(19) United States
(12) Patent Application Publication
(10) Pub. No.: US 2025/0197606 A1
(43) Pub. Date: Jun. 19, 2025

(54) FLAME-RETARDANT VISCOSE AND FABRIC

(71) Applicant: HANGZHOU ANCHUANG TEXTILE CO., LTD., Hangzhou City (CN)

(72) Inventors: PAN-XIANG ZHENG, Hangzhou City (CN); WEI-CAI GUO, Gaomi City (CN); NA HU, Gaomi City (CN)

(21) Appl. No.: 18/539,246

(22) Filed: Dec. 13, 2023

(51) Int. Cl. C08L 1/24

(52) U.S. Cl. CPC C08L 1/24

(57) ABSTRACT

The present invention discloses a flame-retardant viscose. The flame-retardant viscose has a denier of 2.78-3.70 dtex. The flame-retardant viscose consists of a viscose and a composite flame retardant, and the composite flame retardant includes a silicic acid. According to the technical solution, the above flame-retardant viscose has a denier of 2.78-3.70 dtex. The fiber has obviously improved spinning efficiency at such a scope of denier, and the fabric woven after spinning has a long-lasting flame-retarding effect.

### FIELD OF TECHNOLOGY

The present invention falls within the technical field of textiles, and particularly relates to a flame-retardant viscose and a fabric.

### BACKGROUND

The combustion performance of indoor textiles and upholstered furniture is of significant influence on the occurrence and spread of fires. In order to safeguard the safety of person and property, developed countries and regions such as the United States, the European Union, and Canada began to supervise and continuously improve them in the form of legislation since 1950. For example, the US Consumer Product Safety Commission (CPSC) has formulated two standards for the combustion performance of mattresses, i.e., 16 CFR 1632 Standard for the Flammability of Mattresses and Mattress Pads and 16 CFR 1633 Standard for the Flammability (Open-Flame) of Mattress Sets, respectively. Both standards set different requirements for mattresses, and mattresses to be sold in the US market must meet the requirements of these two standards at the same time.

In indoor textiles and upholstered furniture, for example, the mattress cloth is filled with flammable materials such as sponge or latex. Therefore, not only does the mattress cloth need to be flame retardant, but the mattress cloth also need to be won't ruptured after fire disaster, so as to prevent the open flame from spreading to the flammable material and cause a big fire. Moreover, for flame retardant fabrics added with organic flame retardants, such as organic phosphorus or halogen flame retardants, although the flame retardant fabric is not easy to catch fire, but it is easy to be ruptured after encountering a fire disaster, so that the flame will contact the flammable filling inside the flame retardant fabric, causing the combustion of the filling, and expand the rupture in the flame retardant fabric, making the air more circulated and thus, causing a big fire. That is, the flame retardant fabric does not play its role. Therefore, flame retardant fabrics used to cover flammable materials not only need to be flame retardant, but also must be free of rupture when exposed to fire. In other words, the flame retardant fabric must still completely cover the outside of the flammable filling after burning.

In the flame-retardant viscose fiber containing silicic acid, the silicic acid is further polymerized into polysilicic acid in a viscose stock solution, which forms the network-shaped polysilicic acid/polysilicate molecules and combined with a large amount of chemically bound water to have relatively high properties including high temperature resistance and flame retardant effect. Silicic acid after combustion is decomposed into silicon dioxide. Silicon dioxide has high temperature resistance. The remaining components in the flame-retardant viscose generate dense residual carbon, which covers the surface of flammable materials. It is beneficial to isolate the combustion surface from contact with oxygen and heat exchange. Not only is the fabric not easy to burn, but also generates dense residual carbon after burning to prevent the open flame from spreading to the combustibles in the inner layer.

On the other hand, flame retardants containing phosphorus or halogen have a certain degree of toxicity during the combustion process, and there is also a problem of environmental pollution. The silicon-based flame retardant has the characteristics of high efficiency, non-toxicity, low smoke, anti-dripping property, and no pollution. At the same time, it does not produce toxic gas when burned, and only produces a small amount of smoke and CO₂ gas. Compared with other flame retardant fibers, it has low cost, no pollution, and can be naturally biodegraded into organic and inorganic small molecules mixed in the soil, which is very suitable for flame retardant mattress fabric fibers.

In the existing flame-retardant viscose fiber containing silicic acid, there exists an uneven distribution of inorganic nanoparticles. The inorganic silicic acid or its salt is not coated in the aqueous solution, and self-polymerization is prone to occur. Silicic acid can gradually change from monosilicic acid into polysilicic acid by polymerizing, and finally becomes a silicic acid gel, thus causing problems such as accelerated aging of the viscose stock solution, a sharp increase in viscosity and failure to spin. Patent US 20220228301 A1 announced by the present company provides a flame retardant fabric; an inorganic flame retardant component in the flame-retardant viscose fiber is a silicic acid; the silicic acid is coated with a melamine flame-retardant resin on the surface of silicic acid, which can avoid the silicic acid gels with the zinc sulfate in the coagulation bath during spinning process, resulting in the clogging of the filter device. Moreover, the flame retardant viscose fiber improves the limiting oxygen index and flame retardant performance; after being coated, the flame retardant of the fabric is not easy to outflow and denaturation after washing, and gives the flame retardant fabric a long-lasting flame retardant effect. The denier of the flame-retardant viscose fiber is 1.11-2.78 dtex, and the strength is not less than 2.0 N/dtex, which meets the production requirements of spinning. The technical solution in the above patent is up to the qualified flame retardant effect. However, the fiber has a smaller denier and greatly reduced spinning efficiency and thus, limits the promotion of its efficiency in the process of production. Therefore, there is an urgent need for a further improvement in self-technology.

### SUMMARY

The major object of the present invention is to put forward a flame-retardant viscose and a fabric. It is aimed at improving the denier of the flame-retardant viscose, and to expanding the range of application of the flame retardant fabric.

To achieve the above object, the present invention provides a flame-retardant viscose, having a denier of 2.78-3.70 dtex, where
the flame-retardant viscose comprises a viscose and a composite flame retardant, and the composite flame retardant comprises a silicic acid.

Optionally, the flame-retardant viscose has a dry strength of not less than 1.6 cN/dtex and a dry elongation of 18-25%.

Optionally, the flame-retardant viscose has a limiting oxygen index (LOI) value of not less than 32% and a combustion residue of not less than 30%.

Optionally, a mass ratio of the silicic acid in the composite flame retardant to the viscose is 1:(1.5-2.5).

Optionally, the composite flame retardant further comprises a melamine flame-retardant resin, and the silicic acid is coated with the melamine flame-retardant resin.

Optionally, a method for preparing the composite flame retardant comprises the following steps:
mixing and stirring melamine with a formaldehyde solution, adding a dispersing agent, regulating a pH with triethanolamine, and stirring for reaction, to obtain a prepolymer mixture;
dropwisely adding the prepolymer mixture to a silicic acid solution under stirring conditions, and filtering to obtain a uniformly dispersed composite flame retardant.

Optionally, the dispersing agent is styrene-maleic anhydride.

Optionally, the melamine flame-retardant resin is obtained by a copolymerization of melamine and formaldehyde; a mass ratio of the melamine to the formaldehyde in a raw material is (1.5-2.5):(2-4).

Optionally, a mass ratio of the melamine flame-retardant resin to the silicic acid is (0.2-0.3):1.

The present invention further provides a fabric, and the fabric is woven after spinning the above flame-retardant viscose.

According to the technical solution of the present invention, the flame-retardant viscose has a denier of 2.78-3.70 dtex. The fiber has obviously improved spinning efficiency at such a scope of denier, and the fabric woven after spinning has a long-lasting flame-retarding effect.

### DESCRIPTION OF THE EMBODIMENTS

To make the object, technical solutions and advantages of the examples of the present invention clearer, the technical solutions in the examples of the present invention will now be described clearly and completely hereinafter. Obviously, the examples described are merely a portion of the examples in the present invention, but not all the examples.

It needs to be indicated that the one not marked specific conditions in the examples should be subject to conventional conditions or conditions recommended by the manufacturer. The used reagents or instrument not marked a manufacturer should be conventional products available commercially. Moreover, the meaning of “and/or” in the full text includes three parallel solutions. “A and/or B” is set as an example, it includes a solution A, a solution B, or a solution in conformity to A and B at the same time. Furthermore, the technical solution of each example can be combined with each other, but certainly can be achieved by those skilled in the art. The combination of the technical solutions shall be deemed to be inexistence and beyond the scope of protection claimed by the present invention if it is contradictory or cannot be achieved. Based on the examples of the present invention, all the other examples obtained by those skilled in the art without any inventive effort shall fall within the scope of protection of the present invention.

U.S. Publication No. 20220228301 A1 announced by the present company provides a flame retardant fabric; an inorganic flame retardant component in the flame-retardant viscose is a silicic acid; the silicic acid is coated with a melamine flame-retardant resin on the surface of silicic acid, which can avoid the silicic acid gels with the zinc sulfate in the coagulation bath during spinning process, resulting in the clogging of the filter device. Moreover, the flame retardant viscose fiber improves the limiting oxygen index and flame retardant performance; after being coated, the flame retardant of the fabric is not easy to outflow and denaturation after the wash, and give the flame retardant fabric a long-lasting flame retardant effect. The denier of the flame-retardant viscose is 1.11-2.78 dtex, and the strength is not less than 2.0 N/dtex, which meets the production requirements of spinning. The technical solution in the above patent is up to the qualified flame retardant effect. However, the fiber has a smaller denier and greatly reduced spinning efficiency and thus, limits the promotion of its efficiency in the process of production.

In view of this, the present invention provides a flame-retardant viscose; the flame-retardant viscose has a denier of 2.78-3.70 dtex, a dry strength of not less than 1.6 cN/dtex and a dry elongation of 18-25%. Moreover, the flame-retardant viscose has a LOI value of not less than 32% and a combustion residue of not less than 30%.

The flame-retardant viscose includes a viscose and a composite flame retardant, and the composite flame retardant includes a silicic acid and melamine flame-retardant resin, and the silicic acid is coated with the melamine flame-retardant resin. In some embodiments, a mass ratio of the silicic acid in the composite flame retardant to the viscose is (0.39-0.65):1. In the technical solution, the above flame-retardant viscose has had a denier of 2.78-3.70 dtex. The fiber has obviously improved spinning efficiency at such a scope of denier, and the fabric woven after spinning has a long-lasting flame-retarding effect.

The flame-retardant viscose has the following specific preparation process:

### (1) Preparation of a Spinning Stock Solution

A pulp raw material is soaked into a sodium hydroxide solution at a temperature of 53° C. and a concentration of 17%-18%. After 45 minutes, the alkaline liquid dissolved the low-polymerization degree of hemicellulose to obtain the undissolved part, i.e., α-cellulose. Alkali cellulose with a diameter of 15 μm-20 μm is obtained via pressing. The alkali cellulose is crushed and aged. The aging temperature is 20-25° C., and the aging time is 2 h. 30-40% CS2 of α-cellulose by mass is added and mixed for yellowing reaction. The yellowing temperature is 20-25° C., and the yellowing time is 30-60 minutes. Cellulose xanthate is produced; the cellulose xanthate is then dissolved into 5% sodium hydroxide solution to obtain a spinning solution, and then 2% denaturant of α-cellulose is added; the spinning solution is dissolved, filtered, defoamed, and matured in turn to obtain a spinning stock solution.

During the yellowing process, carbon disulfide molecules penetrate into the cellulose through the alkali liquid filled between the cellulose molecules such that the alkali cellulose molecules are bound with sulfonic acid groups, which makes the distance between the cellulose molecules larger, and the structure looser. When cellulose xanthate is dissolved into sodium hydroxide solution to prepare the spinning stock solution, the concentration of NaOH has a great impact on the solubility of sodium cellulose xanthate or the performance of viscose after being dissolved. To increase the concentration of NaOH to a certain range accelerates swelling and dissolution, and the viscosity of the obtained viscose is also lower. The solubility of cellulose xanthate is the best when the NaOH concentration is 4-8%, and the viscosity stability is also up to the maximum. When the concentration of NaOH exceeds 8%, with the increase of the concentration, the dissolving power of the cellulose xanthate decreases, causing the stability of the viscose to decrease, and the viscosity to rise.

### (2) Preparation of a Composite Flame Retardant

Na2O*nSiO2 (where n=1-1.5) is dissolved into pure water at a temperature of 50-80° C. and stirred evenly for 30 minutes, then dilute sulfuric acid solution is slowly added dropwisely; the pH is adjusted to 3-4, to obtain a silicic acid solution. According to parts by mass of silicic acid, 15-25% melamine, and 20-40% formaldehyde (37% formaldehyde solution) are mixed and stirred, and then 1.5-3.0% dispersing agent is added, the pH is adjusted to 9 with triethanolamine; the solution is subjected to high-speed shearing and stirring at 70-80° C. at a stirring speed of 7000-8000 r/min, to obtain the prepolymer mixture. The prepolymer mixture is put into the silicic acid solution by dripping under high-speed stirring and filtered to prepare a uniformly dispersed flame retardant slurry. In this process, sodium silicate is acidified into silicic acid first, and then the silicic acid is wrapped by a polymer of melamine and formaldehyde, to form nano-scale flame retardant particles. The silicic acid particles wrapped with organic matter can be evenly dispersed in the viscose fiber, and the self-polymerization of inorganic silicic acid can be avoided to cause the sharp increase of viscosity, making it impossible to spin.

It has significant influence on the nano-particle size of the composite flame retardant at different stirring speeds; nano-scale solid particles can be obtained at a high rotation speed, and the higher the speed is, the smaller of the average particle size is, but the change of particle size is not obvious when the rotation speed is greater than 7000 r/min.

Styrene-maleic anhydride is used as a dispersing agent, which can reduce the surface tension of the dispersed phase and facilitate dispersion. Thereby, the system can be stabilized and uniform fine particles can be formed. The dispersing effect is not ideal when sodium lauryl sulfate, sodium dodecylbenzene sulfonate, etc. are used as a dispersing agent, and a large amount of silicic acid is not wrapped by organic matter.

### (3) Injecting a Flame Retardant and a Denaturant Before Spinning

The temperature of the spinning solution is controlled at 20-25° C. by a heat exchanger, and the composite flame retardant (where silicic acid accounts for 20-60 wt % of α-cellulose) is injected into the spinning solution through a first pre-spinning injection system; afterwards, the solution is uniformly mixed by a static mixer, and the denaturant is injected through a second pre-spinning injection system, so as to form a spinning stock solution, further, the spinning stock solution of viscose is uniformly mixed by a dynamic and static mixer to obtain a stock solution that can be directly spun.

The denaturant may be selected from the following one or more of aliphatic amine, ethanolamine, polyoxyethylene, polyoxyalkylene glycol, polyethylene glycol, aromatic alcohol, polyol, diethylamine, dimethylamine, cyclohexylamine, and alkylamine polyethylene glycol, and preferably two or more of the above denaturants are used as a mixed denaturant.

(4) In the spinning machine, the spinning stock solution reacts with the coagulation bath while being extruded by a nozzle, to obtain the nascent fiber tow. The coagulation bath includes components of 95-120 g/L sulfuric acid, 25-55 g/L zinc sulfate, 300-350 g/L sodium sulfate; the reaction temperature: 40-50° C., and two bath temperature: 96-100° C.

### (5) Post-Processing:

The nascent fiber tow is further processed by 45-55% spinning disk drafting, 10-16% plasticizing bath drafting, and—1% re-tracing drafting to the aforesaid four drafting and plasticizing and shaping, then, subjected to cutting and post-treatment. The post-treatment processes include pickling, desulfurization, water washing, and oiling; and then drying to obtain the flame-retardant viscose fiber.

The present invention further provides a fabric which is woven by the above flame-retardant viscose. The production process is as follows:

(1) Blowing process: in the opening and cleaning process, the process route of “fine grabbing, less or no falling, more combing and less beating, and full opening” is adopted. The air outlet of the dust cage adopts a full air supply method, the beater speed is 600-800 rpm; the blade extension height is 2.5-3.0 mm; the distance between the needle beater and the integrated beater is 12*20 mm; the distance between dust rods should be as small as 3 mm; the dust rod in the impurity collection area of the beater room is installed reversely to achieve the purpose of reduced or free dropping. In order to prevent the roll from being too bulky and sticky, the volume of the roll weight is appropriately reduced to 350-370 g/m.

(2) Carding process: the carding process must ensure that the fiber web is clear, the number of reps is reduced, and the straightness and separation of the fibers are maintained in the cotton web, the cylinder speed is 300-340 r/min. Moreover, the licker roll speed should be reduced to 600-750 r/min because the licker not only has a strong ability of piercing and dividing the fiber, but also should avoid the licker-in-the-roller. Further, to avoid the cylinder winding around the cotton and card clothing stuffing, the distance between the cylinder and the cover should be controlled 9*9*8*8*7 inches, and the distance between the cylinder and the front cover can be appropriately enlarged to 30*38*38*30 inches, and the tension draft ratio should be small and controlled at 1 to 1.1 times. Also, if there is no smoothness that the fiber strip is bulky and is easy to block the bell mouth and the inclined tube of the coil, the following process measures including to reduce the doffer speed (13-15 r/min), to increase the pressure of the roller (16-18 kg), and to reduce the diameter of the compressed horn (2.6-3.0 mm), to sprinkle talcum powder in the ring channel, to leave sliver on the empty sliver tube before processing, are adopted.

(3) Drawing process: choosing the process principle of “heavy pressure, large gauge, strong control, and slow speed” is the most critical process for the production of flame retardant fibers. The roller gauge should be appropriately enlarged to 15 mm×25 mm during pre-binning to keep the drafting stable. At the same time, it adopts the forward drafting process for configuration, and the drafting ratio is controlled at about 7.0-8.0 times. In addition, the drawing length should be appropriately reduced to 1500-2000 meters to avoid the fiber layer being too high when the capacity is large because the cotton sliver is fluffy. Further, it is easy to stick to the pile cover, wind roller, wind rubber roller, and block the loop channel due to the serious static electricity of the flame retardant fiber during production. For this, the following process measures are able to avoid the blockage of the inclined tube of the coil, and ensure the smooth delivery of the strip, which includes the followings: the relative humidity of the workshop should be controlled at 70-75%, and the top roller should be an anti-static top roller, and the speed of the front roller should be reduced, and the bell mouth and the inclined tube are wiped with alcohol; and talcum powder is sprinkled; the channel is kept clean and smooth to reduce friction resistance; a smaller diameter of a bell mouth (2.6, 2.8) is selected; the pressure of the pressing roller (13.5-14.5 kg) is increased, etc.

(4) Roving process: the roving process is configured using the process of “medium basis weight, heavy pressure, strong control, low speed, large roller gauge and high twist”, which helps stabilize the relationship between the drafting force and the holding force, and prevent “hard ends”. The following step should be done with the basis weight control at 3.0-4.5 g/10 m, and the speed reduction at 500-600 r/min, increase of the roller gauge to 27/38 mm, and the drafting ratio of 7.0-8.0, so as to strengthen the control of the fibers in the drafting zone. Under the same twist coefficient condition, the flame retardant roving structure is relatively loose, so the roving twist coefficient is controlled at 80-100, and the tension elongation is strictly controlled, and the elongation change range of a doff is required to be in the range of 1% to 2%. If the roving is wrapped around the top roller, the top roller is treated using an antistatic coating.

(5) Spinning process: rubber rollers with a hardness of 65 are selected, in addition to increasing the pressure of the rubber roller, measures such as enlarging the apron jaws and increasing the draft ratio of the rear zone (appropriately 1.2 times) should be taken to reduce the drafting force and improve the quality of the yarn. A type-772 traveler is selected to compress the diameter of the air ring and reduce the rate of spun yarn breakage. In addition, the spun yarn twist coefficient can be slightly larger, generally 370-410 can be selected.

(6) Winding process: due to the serious static electricity phenomenon, for ensuring good bobbin forming, the following condition is necessary including: to appropriately reduce the speed of the grooved drum and reduce the tension, and to remain smooth and free of burrs in the yarn channel, and to reduce the deterioration of the sliver and the generation of hairiness. The setting of electrical cleaning parameters focuses on removing coarse details, impurities and reps of single yarn. An air splicer is used as a connector.

(7) The yarn is woven into a flame retardant fabric, the yarn count is 8-32 s, namely 8 s, 10 s, 12 s, 14 s, 16 s, 20 s, 24 s, 26 s, 28 s, and 32 s. Knitted fabrics are obtained after weaving. According to the application scenarios of flame retardant fabrics, such as mattresses, sofas, etc., different fabric weights can be selected. The fabric weights can be 180 g/m2, 220 g/m2, 260 g/m2, 300 g/m2, 330 g/m2, 370 g/m2, the above grain weight+/−10%.

Compared with the prior art, the flame-retardant viscose of the present invention is added with a silicic acid flame retardant coated with an organic material, which improves the LOI value and flame retardation; the LOI is up to more than 32%, and the ash content is greater than 30%. Meanwhile, due to the existence of sub-nano flame retardant particles coated by the melamine resin, the flame retardant in the fabric is not prone to outflow and denaturation after washing, and gives the fabric a long-lasting flame retardant effect.

Moreover, the formula of the composite flame retardant is adjusted and in combination with appropriate spinning technology. The flame-retardant viscose of the present application has a denier being up to 2.78-3.70 tex, and a strength of not less than 1.6 N/dtex. The fiber has obviously improved spinning efficiency at such a scope of denier, which meets the production requirements of crude fiber spinning.

The technical solution of the present invention will be further described in detail with reference to the detailed embodiments. It should be understood that the following examples are merely construed as explaining the present invention, but not construed as limiting the present invention.

### Example 1

### (1) Preparation of a Spinning Stock Solution

A pulp fiber was soaked into a sodium hydroxide solution at a temperature of 53° C. and a concentration of 17%, 45 minutes later, undissolved α-cellulose was obtained; after excessive alkaline liquid was pressed and extruded, the cellulose was crushed to obtain alkali cellulose debris with a diameter of 15 μm-20 μm. The alkali cellulose was then aged; the aging temperature was 20° C., and the aging time was 2 h; then 34% CS2 of α-cellulose by mass was added and mixed for yellowing reaction at a yellowing temperature of 25° C. for 30 minutes to generate cellulose xanthate; the cellulose xanthate was dissolved into 5% sodium hydroxide solution to obtain a spinning solution, and then 2% denaturant of α-cellulose was added; the spinning solution was dissolved, filtered, defoamed, and matured in turn to obtain a spinning stock solution. The index of the spinning stock solution: α-cellulose was 9.21 wt %, alkali content was 5.3 wt %, degree of esterification was 65, and viscosity was 103 s.

### (2) Preparation of a Flame Retardant

Na2O*nSiO2 (where n=1-1.5) was dissolved into pure water at a temperature of 65° C. and stirred evenly for 30 minutes, then dilute sulfuric acid solution was slowly added dropwisely; the pH was adjusted to 3-4, to obtain a silicic acid solution. The silicic acid solution containing 100 parts of silicic acid was taken, and mixed with 10 parts of melamine, and 15 parts of formaldehyde (37% formaldehyde solution) and stirred, and then 1.5% styrene-maleic anhydride was added, the pH was adjusted to 9 with triethanolamine; then the solution was subjected to high-speed shearing and stirring at a stirring speed of 7000-8000 r/min and 75° C., to obtain a prepolymer mixture. The prepolymer mixture was put into the silicic acid solution by dripping under high-speed stirring and filtered to prepare a uniformly dispersed composite flame retardant. The solid content was 42.6%, and the particle size was less than 1 micron.

### (3) Injecting the Flame Retardant Before Spinning

The temperature of the spinning solution was controlled at 25° C. by a heat exchanger, and the composite flame retardant (where silicic acid accounted for 50 wt % of α-cellulose) was injected into the spinning solution through the first pre-spinning injection system; afterwards, the spinning solution was uniformly mixed by a static mixer, and a denaturant, ethanolamine and cyclohexylamine (a mass ratio of 1:1) was injected through a second pre-spinning injection system, so as to form a spinning stock solution of viscose, further, the spinning stock solution of viscose was uniformly mixed by a dynamic and static mixer to obtain the stock solution that can be directly spun.

(4) In the spinning machine, the spinning stock solution reacted with the coagulation bath while being extruded by a nozzle, to obtain the nascent fiber tow. The coagulation bath includes components of 95 g/L sulfuric acid, 25 g/L zinc sulfate, 300 g/L sodium sulfate; the reaction temperature: 45° C., and two bath temperature: 90° C.

### (5) Post-Processing:

The nascent fiber tow was further processed by 54% spinning disk drafting, 12% plasticizing bath drafting, and—1% re-tracing drafting to the aforesaid four drafting and plasticizing and shaping, then, subjected to cutting and post-treatment. The post-treatment processes include pickling, desulfurization, water washing, and oiling; and then drying to obtain the flame-retardant viscose fiber.

Desulfurization: sodium sulfite concentration was 25 g/L, and temperature was 85° C.

Water washing: PH value was 7.5, and temperature was 75° C.

Oil bath: pH was 7-8, temperature was 55° C., and concentration was 10 g/L.

The finished product index of the flame-retardant viscose prepared by the above process: denier was 3.70 dtex, and strength was 1.82 CN/dtex.

### Examples 2-8

In Examples 2-8, other processes and parameters are the same except parts by mass of silicic acid and formaldehyde are changed. The performance parameters of the flame-retardant viscose obtained are shown in Table 1 as below.

TABLE 1
Properties of the flame-retardant viscose obtained
from different proportions of the flame retardant

| | Viscose | Silicic acid | Melamine | | | |
|---|---|---|---|---|---|---|
| | (Part by | (Part by | (Part by | Formaldehyde | Denier | Strength |
| Example | mass) | mass) | mass) | (Part by mass) | (dtex) | (N/dtex) |
| 1 | 200 | 100 | 10 | 15 | 3.70 | 1.82 |
| 2 | 250 | 100 | 12.5 | 17.5 | 2.78 | 2.02 |
| 3 | 150 | 100 | 10 | 10 | 2.83 | 1.60 |
| 4 | 160 | 100 | 8 | 12 | 2.95 | 1.65 |
| 5 | 180 | 100 | 10 | 14 | 3.16 | 1.76 |
| 6 | 200 | 100 | 10 | 16 | 3.27 | 1.87 |
| 7 | 220 | 100 | 10 | 18 | 3.41 | 1.98 |
| 8 | 240 | 100 | 12 | 18 | 3.55 | 1.99 |

It can be seen from the table above that in each example, the denier of the flame-retardant viscose may be up to 2.78-3.70 dtex, and the strength is not less than 1.6 N/dtex; the fiber has obviously improved spinning efficiency at such a scope of denier, and the fabric woven after spinning has a long-lasting flame-retarding effect.

Technical features of the examples may be in any combination. To make the description concise, not all the possible combinations of the technical features of the above examples are described. However, these combinations of the technical features shall fall within the scope of the description as long as there is no contradiction.

The foregoing examples merely represent some embodiments of the present application, and are described more specifically, but cannot be construed as limiting the scope of the invention patent. It should be indicated that those skilled in the art could make some transformations and improvements without departing from the concept of the present application. Moreover, these transformations and improvements shall be deemed to be within the scope of protection of the present application. Therefore, the scope of protection of the present patent application shall be subject to the claims annexed.

What is claimed is:

1. A flame-retardant viscose, having a denier of 2.78-3.70 dtex, wherein:
the flame-retardant viscose comprises a viscose and a composite flame retardant, and the composite flame retardant comprises a silicic acid.

2. The flame-retardant viscose according to claim 1, wherein the flame-retardant viscose has a dry strength of not less than 1.6 cN/dtex and a dry elongation of 18-25%.

3. The flame-retardant viscose according to claim 1, wherein the flame-retardant viscose has a limiting oxygen index (LOI) of not less than 32% and a combustion residue of not less than 30%.

4. The flame-retardant viscose according to claim 1, wherein a mass ratio of the silicic acid in the composite flame retardant to the viscose is 1: (1.5-2.5).

5. The flame-retardant viscose according to claim 1, wherein the composite flame retardant further comprises a melamine flame-retardant resin, and the silicic acid is coated with the melamine flame-retardant resin.

6. The flame-retardant viscose according to claim 5, wherein a method for preparing the composite flame retardant comprises the following steps:
mixing and stirring melamine with a formaldehyde solution, adding a dispersing agent, regulating a pH with triethanolamine, and stirring for reaction, to obtain a prepolymer mixture;
dropwisely adding the prepolymer mixture to a silicic acid solution under stirring conditions, and filtering to obtain a uniformly dispersed composite flame retardant.

7. The flame-retardant viscose according to claim 6, wherein the dispersing agent is styrene-maleic anhydride.

8. The flame-retardant viscose according to claim 5, wherein the melamine flame-retardant resin is obtained by a copolymerization of melamine and formaldehyde; a mass ratio of the melamine to the formaldehyde in a raw material is (1.5-2.5):(2-4).

9. The flame-retardant viscose according to claim 6, wherein the melamine flame-retardant resin is obtained by a copolymerization of melamine and formaldehyde; a mass ratio of the melamine to the formaldehyde in a raw material is (1.5-2.5):(2-4).

10. The flame-retardant viscose according to claim 5, wherein a mass ratio of the melamine flame-retardant resin to the silicic acid is (0.2-0.3):1.

11. A fabric, wherein the fabric is woven after spinning the flame-retardant viscose according to claim 1.
